(19) United States
(12) Patent Application Publication
(10) Pub. No.: US 2019/0121537 A1
(43) Pub. Date: Apr. 25, 2019

(54) INFORMATION DISPLAYING METHOD AND DEVICE, AND ELECTRONIC DEVICE

(71) Applicant: BEIJING KINGSOFT INTERNET SECURITY SOFTWARE CO., LTD., Beijing (CN)

(72) Inventors: Szuhan Wu, Beijing (CN); Weiting Chen, Beijing (CN); Jianming Zhu, Beijing (CN); Chungyuan Wang, Beijing (CN); Yunjiun Yang, Beijing (CN); Chiahung Kao, Beijing (CN); Chiachi Liu, Beijing (CN); Chungpeng Tsai, Beijing (CN); Guanlin Ciou, Beijing (CN); Chifeng Chang, Beijing (CN); Chihfong Lin, Beijing (CN); Chiachi Huang, Beijing (CN); Tingyang Wei, Beijing (CN); Chuanjung Huang, Beijing (CN)

(73) Assignee: BEIJING KINGSOFT INTERNET SECURITY SOFTWARE CO., LTD., Beijing (CN)

(21) Appl. No.: 16/186,759

(22) Filed: Nov. 12, 2018

Related U.S. Application Data
(63) Continuation of application No. PCT/CN2017/071976, filed on Jan. 20, 2017.

(30) Foreign Application Priority Data
May 12, 2016 (CN) 201610317545.4

(51) Int. Cl. G06F 3/0488; G06F 3/0486; G06F 3/0481

(52) U.S. Cl. CPC G06F 3/04883; G06F 3/0481; G06F 3/0486

(57) ABSTRACT

Embodiments of the present disclosure relate to an information displaying method, an information displaying device, and an electronic device. The method includes: when an activated device screen is in a user interface locked state, displaying a prompting object of a new screen interface on the device screen; detecting a touch operation of a user on the prompting object of the new screen interface; judging whether the detected touch operation satisfies a preset information displaying condition; and in response to the detected touch operation satisfying the preset information displaying condition, loading the new screen interface.

### CROSS-REFERENCE TO RELATED APPLICATIONS

This application is a continuation application of International Application No. PCT/CN2017/071976, which claims priority to and benefits of Chinese Patent Application Serial No. 201610317545.4, filed with the State Intellectual Property Office of P. R. China on May 12, 2016, by BEIJING KINGSOFT INTERNET SECURITY SOFTWARECO., LTD., and titled with “METHOD AND APPARATUS FOR DISPLAYING INFORMATION, AND ELECTRONIC DEVICE”, the entire content of each of which are incorporated herein by reference.

### FIELD

The present disclosure relates to an information application technology field, and more particularly to an information displaying method, an information displaying device and an electronic device.

### BACKGROUND

With the continuous development of computer communication and Internet technology, electronic devices, such as smart mobile phones, personal digital assistants, handheld computers, notebook computers, etc., are becoming more and more widely used, and more and more applications (APP) are installed, greatly meeting personalized demands of different users. Since the existing electronic devices are generally equipped with large screens, in a case that the frequency and time of the user using the electronic device are increasing, the screen of an electronic device is locked if the user does not use the electronic device based on a purpose of power saving, privacy protection, and prevention of misoperation. That is the screen of the electronic device is set to off when the user does not use the electronic device, such that an operating system of the electronic device enters a sleep state, thereby saving power of the electronic device and improving privacy and security of the user. When the screen of the electronic device is locked, the electronic device screen is set to a black screen or set to a pre-selected still picture. When the electronic device receives a message (for example, a short message or pushed information) or the electronic device is to be used, the screen is lighted to prompt the user to unlock the screen or the screen is directly unlocked, thereby the operating system is entered to perform corresponding operations.

According to statistics, a user generally receives dozens of pieces of pushed information every day, and the screen of the electronic device is lighted for dozens of times correspondingly. If the user needs to view specific content of the received information or the user actively views some information, the user needs to input an unlocking password in the lighted screen.

### SUMMARY

Embodiments of the present disclosure provide an information displaying method, device and an electronic device.

An information displaying method is provided. The method includes: when an activated device screen is in a user interface locked state, displaying a prompting object of a new screen interface on the device screen; detecting a touch operation of a user on the prompting object of the new screen interface; judging whether the detected touch operation satisfies a preset information displaying condition; and in response to the detected touch operation satisfying the preset information displaying condition, loading the new screen interface.

An information displaying device is provided. The device includes: a module of displaying a prompting object of a new screen interface, a detecting module, a judging module, and a new screen interface loading module, in which, the module of displaying the prompting object of the new screen interface is configured to, when an activated device screen is in a user interface locked state, display, a prompting object of a new screen interface on the device screen; the detecting module is configured to detect a touch operation of a user on the prompting object of the new screen interface; the judging module is configured to judge whether the detected touch operation satisfies a preset information displaying condition; the new screen interface loading module is configured to, in response to the detected touch operation satisfying the preset information displaying condition, load the new screen interface.

An electronic device is provided. The electronic device includes: a housing, a processor, a memory, a circuit board, and a power circuit, in which, the circuit board is arranged inside a space enclosed by the housing; the processor and the memory are disposed on the circuit board; the power circuit is configured to provide power for individual respective circuits or components of the electronic device; the memory is configured to store executable program codes; and the processor, by reading the executable program code stored in the memory, is configured to run a program corresponding to the executable program codes by reading the executable program codes stored in the memory, so as to perform any one of the above mentioned information displaying method.

A storage medium is provided. The storage medium is configured to store an application, in which the application is configured to perform the information displaying method.

### BRIEF DESCRIPTION OF THE DRAWINGS

In order to explicitly illustrate technical solutions in embodiments of the present disclosure, a brief introduction for the accompanying drawings used when describing the embodiments will be listed as follows. Apparently, the drawings described below are only corresponding to some embodiments of the present disclosure, and those skilled in the art may obtain other drawings according to these drawings without creative labor.

FIG. 1 is a flow chart of an information displaying method according to a first embodiment of the present disclosure;

FIG. 2 is a flow chart of an information displaying method according to a second embodiment of the present disclosure;

FIG. 3 is a block diagram illustrating an information displaying device according to a third embodiment of the present disclosure;

FIG. 4 is a block diagram illustrating an electronic device according to an embodiment of the present disclosure.

### DETAILED DESCRIPTION

Embodiments of the present disclosure will be described in detail in combination drawings.

It should be noted that, the described embodiments are only part of embodiments of the present disclosure, instead of the entire embodiments. Based on embodiments described herein, those skilled in the art may obtain all other embodiments without creative labor, which belongs to the protection scope of the present disclosure.

FIG. 1 is a flow chart of an information displaying method according to a first embodiment of the present disclosure. As illustrated in FIG. 1, the method according to this embodiment may include follows.

At block 101, when an activated device screen is in a user interface locked state, a prompting object of a new screen interface is displayed on the device screen.

In embodiments of the present disclosure, the prompting object of the new screen interface may be a prompting image, a graphic interactive user interface object which the user interacts with to perform a user's touch operation to load a new screen page.

The prompting object of the new screen interface is a graphic interactive user interface object displayed on a locked application interface when the device screen is activated and when a locking application is started. There may be many ways for activating the device screen and starting the locking application. For example, one of most common ways may be that the user activates the screen (i.e., also called lighting the screen) of a mobile terminal by manually pressing a physical button (such as a power button or a home button) on the mobile terminal when the screen of the mobile terminal is in an off state. At this time, the locking application may be started. Alternatively, in another way, when the mobile terminal receives a message pushed by a server, the screen may be woken up and automatically lighted, at this time, the locking application may also be started.

In an alternatively embodiment, displaying the prompting object of the new screen interface on the device screen includes: displaying the prompting object of the new screen interface on a preset position of the device screen.

In an alternatively embodiment, the prompting object of the new screen interface may be a widget.

In an alternatively embodiment, a shape of the prompting object of the new screen interface may include but not limit to: a triangle, a bar, a round, a polygon, and the like.

In embodiments of the present disclosure, for example, a new screen prompting interface object with a triangle shape (a triangle widget) may be set at both a left sidebar of the screen and a right sidebar of the screen, such that a user used to sliding the screen with both left and right hand can easily position the triangle widget. Certainly, in practical application, the triangle widget may be set at the left sidebar of the screen for a user used to sliding the screen with left hand, and the triangle widget may be set at the right sidebar of the screen for a user used to sliding the screen with right hand, which is not limited herein.

In some embodiments, as an alternatively embodiment, determining a color of the prompting object of the new screen interface includes follows.

At B11, a pixel value of each of pixels in a preset range centered on the preset position is obtained.

In some embodiments, a pixel value of each surrounding pixel centering on the preset position is extracted. For example, if the preset position is a center of the left sidebar of the screen, pixel values of nine or sixteen pixels centered on the center of the left sidebar in a wallpaper of the device screen may be extracted.

At B12, a mean pixel value is calculated according to pixel values of the pixels in the preset range.

At B13, a mapping relationship between pixel values and reference pixel values is inquired, and a reference pixel value corresponding to the mean pixel value is obtained.

At B14, the color of the prompting object of the new screen interface is set to the obtained reference pixel value.

In some embodiments, in order to facilitate the user to recognize the prompting object of the new screen interface presented on the device screen, a color of the presented prompting object of the new screen interface is set to form a contrast color with a color of wallpaper of a region where the prompting object of the new screen interface locates, so that the prompting object of the new screen interface is easy to be distinguished. At the same time, the color of the presented prompting object of the new screen interface may vary with the color of the wallpaper, thus to improve user's visual experience.

As an alternatively embodiment, after the prompting object of the new screen interface is displayed on the device screen, if the displayed prompting object of the new screen interface satisfying a preset enhanced prompting condition, an enhanced prompting animation corresponding to the enhanced prompting condition may be displayed.

The enhanced prompting animation is configured to prompt the user to operate on the prompting object of the new screen interface to load and display the new screen interface. As an alternatively embodiment, the enhanced prompting animation may be a corrugated animation centering on and spread out from the new screen prompt object according to a preset shape and/or a preset time period.

The enhanced prompting condition may include: displaying, for a first time, the prompting object of the new screen interface during a preset time period, and/or failing to detect the touch operation of the user on the prompting object of the new screen interface during a preset time period. For example, when the prompting object of the new screen interface is displayed for the first time in a day, or when the user actively activates the device screen but does not unlock the device to enter an operating system, a prompting animation may be used for prompting the user to drag the prompting object of the new screen interface, so as to view information pages in the loaded and displayed new screen interface.

At block 102, a touch operation of a user is detected on the prompting object of a new screen interface.

At block 103, it is judged whether the detected touch operation satisfies a preset information displaying condition.

The touch operation of the user on the prompting object of a new screen interface may include a click, a release, a drag, and the like.

In an embodiment, as an alternatively embodiment, judging whether the detected touch operation satisfies the preset information displaying condition includes: in response to a displacement of dragging the prompting object of the new screen interface greater than a first distance threshold in a preset dragging direction on the device screen, determining the detected touch operation satisfies the preset information displaying condition.

In an embodiment, as an alternatively embodiment, in response to a displacement of dragging the prompting object of the new screen interface greater than a first distance threshold in a preset dragging direction on the device screen, determining the detected touch operation satisfies the preset information displaying condition includes follows.

C11, a starting position of clicking the prompting object of the new screen interface is recorded.

In some embodiments, the position of clicking the prompting object of the new screen interface is a center of the preset position.

C12, an ending position of releasing the prompting object of the new screen interface is recorded.

In some embodiments, by clicking and dragging the prompting object of the new screen interface, misoperation of the user may be effectively avoided.

As an alternatively embodiment, during a dragging process from clicking the prompting object of the new screen interface to releasing the prompting object of the new screen interface, the method further includes: inquiring a preset correspondence relationship between a dragging displacement and a size of the prompting object of the new screen interface, displaying the prompting object of the new screen interface according to the size of the prompting object of the new screen interface corresponding to a dragging distance of the prompting object of the new screen interface in an animation way.

In an embodiment, for example, the user may click and drag a triangle widget in the device screen from one side of the screen to the other side, and an area of region corresponding to the triangle widget may gradually increase with an increasing dragging distance.

C13, a displacement from the starting position to the ending position is calculated.

C14, a dragging direction is determined according to the displacement, and a main dragging displacement from the starting position to the ending position in the dragging direction is calculated.

In some embodiments, the device screen may be taken as a reference, by comparing main displacements of the prompting object of the new screen interface in horizontal and vertical, a direction corresponding to a greater main displacement is selected as the dragging direction, thus it may be determined whether the prompting object of the new screen interface is dragged in horizontal or dragged in vertical.

C15, if the main dragging displacement is greater than a first distance threshold in a preset dragging direction of the device screen, it is determined that the detected touch operation satisfies the preset information displaying condition.

In some embodiments, the first distance threshold may be set as a half of a length in the dragging direction of the device screen. If the prompting object of the new screen interface is dragged in horizontal and if a dragging distance in horizontal is greater than a horizontal length of the device screen, or the prompting object of the new screen interface is dragged in vertical and if a dragging distance in vertical is greater than a vertical length of the device screen, it is determined that the prompting object of the new screen interface is dragged further than the preset dragging distance threshold.

In some embodiments, if the main dragging displacement is not greater than the first distance threshold in the preset dragging direction of the device screen, the detected touch operation does not satisfy the preset information displaying condition. At this time, the prompting object of the new screen interface returns to original state.

As an alternative embodiment, judging whether the detected touch operation satisfies the preset information displaying condition may include: in response to a displacement of dragging the prompting object of the new screen interface greater than a second distance threshold in a preset dragging direction on the device screen and smaller than a first distance threshold, calculating a time period from beginning of touching the prompting object of the new screen interface to releasing the prompting object of the new screen interface during dragging; and in response to the time period greater than a preset time period threshold, determining that the detected touch operation satisfies the preset information displaying condition.

In some embodiments, if the main dragging displacement is greater than the second distance threshold and smaller than the first distance threshold in the dragging direction of the device screen, the time period from beginning of clicking the prompting object of the new screen interface to releasing the prompting object of the new screen interface is calculated. If the time period is greater than the preset time period threshold, it is determined that the detected touch operation satisfies the preset information displaying condition.

In some embodiments, the second distance threshold may be set as a quarter of a length in the dragging direction of the device screen. As an alternative embodiment, the time period may be preset or set by the user. For example, the time period may be set as 0.25 s, 0.3 s or the like.

Similarly, in some embodiments, if the main dragging displacement is greater than a quarter of the length in the dragging direction of the device screen and smaller than a half of the length in the dragging direction of the device screen and if the time period is not greater than the preset time period threshold, or if the main dragging displacement is not greater than a quarter of the length in the dragging direction of the device screen, the prompting object of the new screen interface returns to original state.

As an alternative embodiment, after the prompting object of the new screen interface is displayed on the device screen, if the touch operation does not satisfy the preset information displaying condition when it is detected that the user performs the touch operation on the prompting object of the new screen interface, the prompting object of the new screen interface may change its position according to the dragging operation of the user. When the user stops dragging and releases the prompting object of the new screen interface, the prompting object of the new screen interface may be displayed a corresponding position of the device screen, such as a nearest sidebar of the device screen.

At block 104, in response to the detected touch operation satisfying the preset information displaying condition, the new screen interface is loaded.

In some embodiments, as an alternative embodiment, loading the new screen interface may include obtaining attribute information of the activated device screen, and loading a page corresponding to the attribute information in the new screen interface.

In some embodiments, when the new screen interface is loaded, an attribute of the new screen interface may be set as displaying. At the same time, an attribute of a locking screen interface of the device screen is updated to hiding from displaying.

In some embodiments, as an alternative embodiment, when the new screen interface is loaded, the attribute information of the activated device screen is obtained, and the page corresponding to the attribute information in the new screen interface is loaded.

In some embodiments, as an alternative embodiment, the step of obtaining attribute information of the activated device screen and loading the page corresponding to the attribute information in the new screen interface includes displaying content of the new message in the new screen interface if the attribute information of the activated device screen is receiving a new message.

In some embodiments, as an alternative embodiment, the new message may include but is not limited to text information, an image, a video, an audio, an animation, a link, an application package, and the like.

In some embodiments, for example, if the new message is news broadcast message containing a title only, the particular content of the news broadcast message may be displayed in the new screen interface. If the new message is a uniform resource locator information of a webpage, a webpage corresponding to the uniform resource locator information may be displayed in the new screen interface. The user may open a sub webpage contained in the webpage by a click in the webpage.

In some embodiments, as an alternative embodiment, if the attribute information of the activated device screen is receiving a new message, before the content of the new message is displayed in the new screen interface, the method may further include judging whether the new message is a private message; if not, performing the step of displaying the content of the new message in the new screen interface.

In some embodiments, if the new message is the private message, the new message is not displayed and the process is ended.

In some embodiments, as another alternative embodiment, the step of obtaining attribute information of the activated device screen and loading the page corresponding to the attribute information in the new screen interface includes displaying a preset information page in the new screen interface in response to the attribute information of the activated device screen being operation of the user on an electronic device.

In some embodiments, if the user triggers the activated screen, in order to reduce tedious operation of the user to unlock the screen, the preset information page may be directly loaded and displayed in the new screen interface, so that the user may obtain relevant information quickly.

In some embodiments, content contained in the information page may be set according to actual practice by the user, for example, set by the user or set a webpage for web guide existing in the internet as the information page.

In some embodiments, when the user drags a triangle widget, loading the preset information page is triggered. As another alternative embodiment, the information page may include four label pages to display different information. The four label pages may include a public application page, a pushing information page, a weather forecast webpage and a game webpage.

For the application public page, an application in the page may connect to an application installed in the electronic device of the user. The page displaying the preset application may be set by the user. For example, the public application page may be set in consideration of a privacy problem when displaying in the screen locked state. The public application page may include but is not limited to a page of WeChat public platform, a page of fans in Facebook, an Instagram page, or the like. Personalized content about a country, a language, a race, a subscription habit or a favor may be provided in the public application page. Certainly, in practical application, a private application page containing a private conversation page, a group conversation page or the like may be also set by the user.

In the public application page displayed in the new screen interface, if the user clicks an image or a text link in an information stream, a detail page corresponding to the image or the text link may be jumped to and loaded in the screen locked state.

The pushing information page contains a page corresponding to a push information stream based on user's favor. For example, if it is known that the user favors a news hotspot page, a sport live page, or the like by analyzing user's browsing history behavior, the news hotspot page and the sport live page may be set into the pushing information page. When the user clicks an image or a text link, a detail page corresponding to the image or the text link may be jumped to and loaded in the screen locked state.

As an alternatively embodiment, when the pushing information page is set, an identification of the electronic device may be sent to a network server. The network server search in a correspondence relationship between an identification of an electronic device and a pushing information page set to obtain one or more pushing information pages corresponding to the received identification of the electronic device, and loads the one or more pushing information pages in a preset information page.

The weather forecast page is configured to display weather information in real time and to forecast weather in a week. In displaying weather information stream, a promoting card may be inserted and displayed. When the user clicks the promoting card, a relevant application may be installed, or other detail information page may be jumped to, or a page of other application may be jumped to.

The game page is configured to display games such as H5 game. In some embodiments, rules of H5 game are simple, with a fast process and short time. The user can directly enter the game session by a click, thus it is suitable for the user to play and entertain under the screen locked state.

In some embodiments, as an alternatively embodiment, a promoting card corresponding to a preset rule may be further inserted in the displayed information stream of the information page according to the preset rule.

In some embodiments, as another alternatively embodiment, the information page may further include other label page, which is not limited herein.

With the information displaying method according to embodiments of the present disclosure, when the activated device screen is in the user interface locked state, the prompting object of the new screen interface is displayed on the device screen, the touch operation of the user is detected on the prompting object of the new screen interface, it is judged whether the detected touch operation satisfies the preset information displaying condition, in response to the detected touch operation satisfying the preset information displaying condition, the new screen interface is loaded, then various pages may be loaded in the new screen interface. Thereby, when the user wishes to view detail content of the received message or when the user needs to positively view some information, the new screen interface may be directly loaded and relevant information may be displayed in the new screen interface, thus guiding the user to view and use various and rich information displayed in the new screen interface in a novel interaction mode, without requiring the user to enter the password for unlock in the lighted screen, simplifying operation process of the user for viewing detail content of the information, shorting the time period of the user for viewing information, improving convenience of the locking screen application in the locked screen state, enabling the user to effectively utilize fragmentation time, thereby improving the user's experience of viewing information. Further, since the information can be viewed without unlocking the screen, the user's willingness to view the information is enhanced, and the information push efficiency is improved. In addition, if the user's family member or friend wishes to view the information through the electronic device, the information can be viewed without unlocking the screen, thereby improving the utilization rate of the electronic device and the experience of other users.

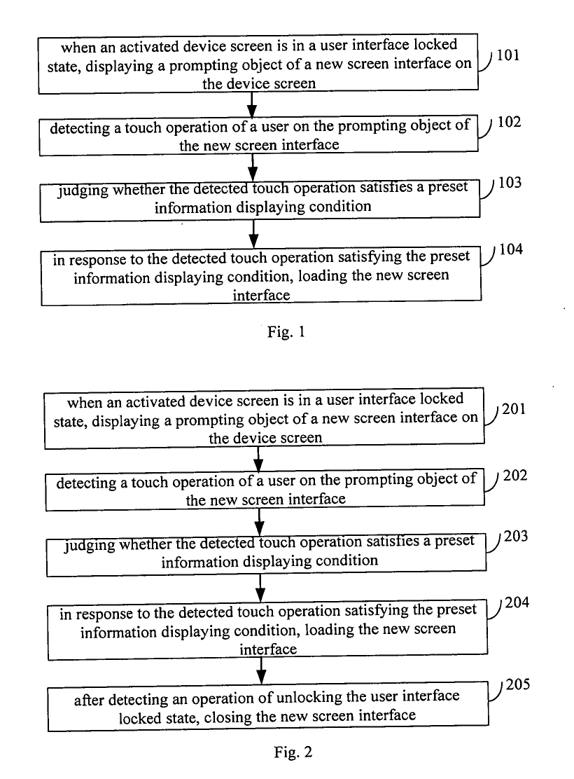

FIG. 2 is a flow chart of an information displaying method according to a second embodiment of the present disclosure. As illustrated in FIG. 2, the method according to this embodiment may include follows.

At block 201, when an activated device screen is in a user interface locked state, a prompting object of a new screen interface is displayed on the device screen.

At block 202, a touch operation of a user is detected on the prompting object of a new screen interface.

At block 203, it is judged whether the detected touch operation satisfies a preset information displaying condition.

At block 204, in response to the detected touch operation satisfying the preset information displaying condition, the new screen interface is loaded.

In this embodiment, the steps at block 201-204 are similar as the steps at block 101-104 in the above method embodiment, which is not elaborated herein.

At block 205, after detecting an operation of unlocking the user interface locked state, the new screen interface is closed.

In some embodiments, when it is detected that the user unlocks the screen and the operating system of the electronic device is entered, the new screen interface is automatically closed and quit.

With the information displaying method according to embodiments of the present disclosure, after the user unlocks the screen, the new screen interface is automatically closed and quit, thus the new screen interface does not occupy source of the electronic device, the user may use the electronic device smoothly.

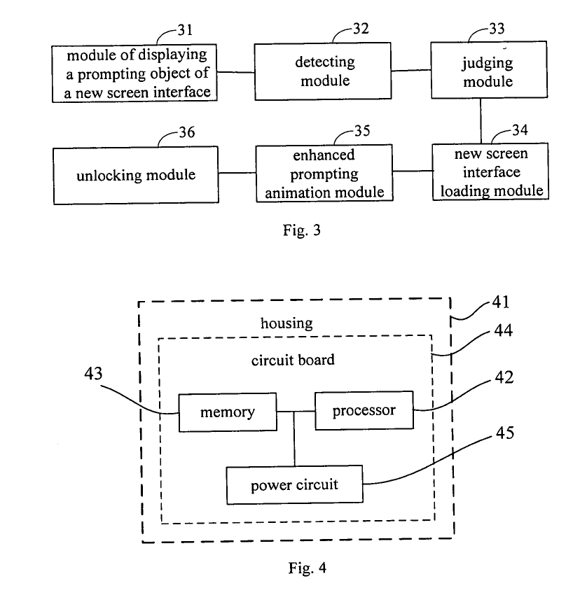

FIG. 3 is a block diagram illustrating an information displaying device according to a third embodiment of the present disclosure. As illustrated in FIG. 3, the device according to this embodiment may include a module 31 of displaying a prompting object of a new screen interface, a detecting module 32, a judging module 33, and a new screen interface loading module 34.

The module 31 of displaying the prompting object of the new screen interface is configured to, when an activated device screen is in a user interface locked state, display a prompting object of a new screen interface on the device screen.

As an alternatively embodiment, the module 31 of displaying the prompting object of the new screen interface includes a lock-screen monitoring unit and a unit of displaying the prompting object of the new screen interface (not shown in the drawings).

The lock-screen monitoring unit is configured to, in response to the activated device screen being in the user interface locked state, inform the unit of displaying the prompting object of the new screen interface.

The unit of displaying the prompting object of the new screen interface is configured to display the prompting object of the new screen interface on the device screen.

In some embodiments, as an alternatively embodiment, the unit of displaying the prompting object of the new screen interface includes a pixel value obtaining sub unit, a calculating sub unit, an inquiring sub unit, and a sub unit of displaying the prompting object of the new screen interface.

The pixel value obtaining sub unit is configured to obtain a pixel value of each of pixels in a preset range centered on the preset position.

The calculating sub unit is configured to calculate a mean pixel value according to pixel values of the pixels in the preset range.

The inquiring sub unit is configured to inquire a mapping relationship between pixel values and reference pixel values, to obtain a reference pixel value corresponding to the mean pixel value.

The sub unit of displaying the prompting object of the new screen interface is configured to set the color of the prompting object of the new screen interface to the obtained reference pixel value.

In some embodiments, as an alternatively embodiment, a shape of the prompting object of the new screen interface may include but not limit to: a triangle, a bar, a round, a polygon, and the like.

The detecting module 32 is configured to detect a touch operation of a user on the prompting object of the new screen interface.

The judging module 33 is configured to judge whether the detected touch operation satisfies a preset information displaying condition.

In some embodiments, as an alternatively embodiment, a wallpaper of the new screen interface is same as a wallpaper under the locked screen state.

In some embodiments, as an alternatively embodiment, the judging module 33 includes a dragging displacement obtaining unit, and a condition determining unit (not shown in the drawings).

The dragging displacement obtaining unit is configured to obtain a displacement of dragging the prompting object of the new screen interface, and in response to the displacement of dragging the prompting object of the new screen interface greater than a first distance threshold in a preset dragging direction on the device screen, to inform the condition determining unit.

The condition determining unit is configured to determine the detected touch operation satisfies the preset information displaying condition.

As another alternatively embodiment, the judging module 33 includes a judging unit, a time period calculating unit, a time period determining unit, and a determining unit (not shown in the drawings).

The judging unit is configured to, in response to a displacement of dragging the prompting object of the new screen interface greater than a second distance threshold in a preset dragging direction on the device screen and smaller than a first distance threshold, inform the time period calculating unit.

The time period calculating unit is configured to calculate a time period from beginning of touching the prompting object of the new screen interface to releasing the prompting object of the new screen interface during dragging.

The time period determining unit is configured to, in response to the time period greater than a preset time period threshold, inform the determining unit.

The determining unit is configured to determine that the detected touch operation satisfies the preset information displaying condition.

As an alternatively embodiment, the device further includes an enhanced prompting animation module 305, configured to, in response to displayed prompting object of the new screen interface satisfying a preset enhanced prompting condition, display an enhanced prompting animation corresponding to the enhanced prompting condition.

In some embodiments, the enhanced prompting condition includes: displaying, for a first time, the prompting object of the new screen interface during a preset time period; and/or failing to detect the touch operation of the user on the prompting object of the new screen interface during a preset time period.

The new screen interface loading module 34 is configured to, in response to the detected touch operation satisfying the preset information displaying condition, load the new screen interface.

In some embodiments, as an alternatively embodiment, the new screen interface loading module 34 includes a touch operation judging unit and a new screen interface loading unit (not shown in the drawings).

The touch operation judging unit is configured to, in response to the detected touch operation satisfying the preset information displaying condition, inform the new screen interface loading unit.

The new screen interface loading unit is configured to obtain attribute information of the activated device screen, and to load the page corresponding to the attribute information in the new screen interface.

As an alternatively embodiment, the new screen interface loading unit includes a first loading sub unit and a second loading sub unit.

The first loading sub unit is configured to, in response to the attribute information of the activated device screen being receiving a new message, display content of the new message in the new screen interface.

The second loading sub unit is configured to, in response to the attribute information of the activated device screen being operation of the user on an electronic device, display a preset information page in the new screen interface.

In some embodiments, as an alternatively embodiment, the information page includes a public application page, a pushing information page, a weather forecast webpage and a game webpage.

In some embodiments, as an alternatively embodiment, a promoting card corresponding to a preset rule may be further inserted in the displayed information stream of the information page according to the preset rule.

In some embodiments, as another alternatively embodiment, the information page may further include other label page, which is not limited herein.

As an alternatively embodiment, the device may further include an unlocking module 36, configured to close the new screen interface after detecting an operation of unlocking the user interface locked state.

The information displaying device according to embodiments of the present disclosure may be used to perform the technical solutions of the method embodiments illustrated in FIG. 1.

Implementation principle and technical effect of the device and the methods are similar, which are not be elaborated herein.

It should be noted that relationship terms such as first and second are only used herein to distinguish an entity or operation from another entity or operation, and it is not necessarily required or implied that there are any actual relationship or order of this kind between those entities and operations. Moreover, terms such as “comprise”, “comprising” and any other variants are intended to cover non-exclusive contains, so that the processes, methods, articles or devices including a series of elements not only include those elements but also include other elements that are not listed definitely, or also include the elements inherent in the processes, methods, articles or devices. In the case of no more restrictions, the elements defined by the statement ‘comprise one . . . ’ do not exclude that other same elements also exist in the processes, methods, articles or devices including the elements.

Each embodiment in the specification is described in a relevant manner. For same or similar parts in the embodiments, reference may be made to each other. What is different from other embodiments is emphasized in each embodiment.

In particular, for the device embodiment, because it is basically similar to the method embodiment, the apparatus embodiment is described simply, and for a relevant part thereof, reference may be made to part of the description of the method embodiment.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination.

In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Embodiments of the present disclosure further provide an electronic device. The electronic device includes the information displaying device according to any one of above-mentioned embodiments.

FIG. 4 is a block diagram illustrating an electronic device according to an embodiment of the present disclosure. The electronic device may implement any processing of embodiment illustrated in FIG. 1 to FIG. 3 of the present disclosure. As illustrated in FIG. 4, above-mentioned electronic device may include: a housing 41, a processor 42, a memory 43, a circuit board 44, and a power circuit 45. The circuit board 44 is arranged inside a space enclosed by the housing 41. The processor 42 and the memory 43 are disposed on the circuit board 44. The power circuit 45 is configured to provide power for individual respective circuits or components of the electronic device. The memory 43 is configured to store executable program codes. The processor 42, by reading the executable program code stored in the memory 43, is configured to run a program corresponding to the executable program codes by reading the executable program codes stored in the memory 43, so as to perform an information displaying method according to any one of above-mentioned embodiments.

For specific execution processes of the foregoing steps executed by the processor 42 and steps performed by the processor 42 by running the executable program code, reference may be made to the description of the embodiments illustrated in any one of FIG. 1 to FIG. 3 of the present disclosure, and details are not described herein again.

The electronic device may have various forms, including but not limited to follows.

(1) A mobile communication device: this typed device has a capacity of mobile communication, and has a main function of providing voice, data communication. This typed terminal includes a smart phone (such as an iPhone), a multi-media phone, a functional phone and a low-level phone.

(2) A super-mobile personal computer device: this typed device pertains to a personal computer having a capacity of computing and processing and generally having a capacity of accessing mobile Internet. This typed device includes: a PDA (Personal Digital Assistant), a MID (Mobile Internet Device) and UMPC devices (Ultra-mobile Personal Computer), such as an iPad.

(3) Portable entertainment equipment: this typed device may display or play multi-medium content. This typed device includes: an audio and/or video player (such as an iPod), a handheld game player, an E-book, intelligent playthings, and portable vehicle navigation equipment.

(4) A server: a device provides calculation service. The server consists of a processor, a hard disk, a memory, a system bus, etc. The server is similar to universal computer architecture. However, because of a need to provide highly reliable services, requirements for processing capacity, stability, reliability, security, scalability, and manageability and other aspects are high.

(5) Other electronic device having a capacity of data interaction.

Ordinary skilled in the art can understand that implementation of all or part of the steps carried by the method of the above embodiments can be completed by a program to instruct related hardware. The program can be stored in a computer readable storage medium, when executed, including one or a combination of the steps of the method embodiments.

For the sake of convenience of description, the above description is described in terms of functions described in various units/modules. Certainly, the functionality of each unit/module may be implemented in the same or more software and/or hardware when implementing this disclosure.

It will be apparent to those skilled in the art from the above description of the embodiments that the present disclosure can be implemented by means of software and a necessary universal hardware platform. Based on such understanding, the technical solution of the present disclosure, which is essential or contributes to the prior art, may be embodied in the form of a software product, which may be stored in a storage medium such as a ROM/RAM, a disk, an optical disk, etc., including instructions for causing a computer device (which may be a personal computer, a server, or a network device, etc.) to perform the methods described in respective embodiments or some part of the embodiments of the present disclosure.

The above are only specific embodiments of the present disclosure, but the scope of the present disclosure is not limited thereto, and any person skilled in the art can easily think of changes or alternatives within the technical scope of the present disclosure. All should be covered by the scope of the present disclosure. Therefore, the scope of the present disclosure should be determined by the scope of the claims.

What is claimed is:

1. An information displaying method, comprising:
when an activated device screen is in a user interface locked state, displaying a prompting object of a new screen interface on the device screen;
detecting a touch operation of a user on the prompting object of the new screen interface;
judging whether the detected touch operation satisfies a preset information displaying condition; and
in response to the detected touch operation satisfying the preset information displaying condition, loading the new screen interface.

2. The method according to claim 1, wherein displaying the prompting object of the new screen interface on the device screen comprises:
displaying the prompting object of the new screen interface on a preset position of the device screen.

3. The method according to claim 2, further comprising:
determining a color of the prompting object of the new screen interface,
wherein determining the color of the prompting object of the new screen interface comprises:
obtaining a pixel value of each of pixels in a preset range centered on the preset position;
calculating a mean pixel value according to pixel values of the pixels in the preset range;
inquiring a mapping relationship between pixel values and reference pixel values, obtaining a reference pixel value corresponding to the mean pixel value; and
setting the color of the prompting object of the new screen interface to the obtained reference pixel value.

4. The method according to claim 1, wherein judging whether the detected touch operation satisfies the preset information displaying condition comprises:
in response to a displacement of dragging the prompting object of the new screen interface greater than a first distance threshold in a preset dragging direction on the device screen, determining the detected touch operation satisfies the preset information displaying condition.

5. The method according to claim 1, wherein judging whether the detected touch operation satisfies the preset information displaying condition comprises:
in response to a displacement of dragging the prompting object of the new screen interface greater than a second distance threshold in a preset dragging direction on the device screen and smaller than a first distance threshold, calculating a time period from beginning of touching the prompting object of the new screen interface to releasing the prompting object of the new screen interface during dragging; and
in response to the time period greater than a preset time period threshold, determining that the detected touch operation satisfies the preset information displaying condition.

6. The method according to claim 1, further comprising:
in response to the displayed prompting object of the new screen interface satisfying a preset enhanced prompting condition, displaying an enhanced prompting animation corresponding to the enhanced prompting condition.

7. The method according to claim 6, wherein the enhanced prompting condition comprises:
displaying, for a first time, the prompting object of the new screen interface during a preset time period; and/or
failing to detect the touch operation of the user on the prompting object of the new screen interface during a preset time period.

8. The method according to claim 1, wherein loading the new screen interface comprises:
obtaining attribute information of the activated device screen, and loading a page corresponding to the attribute information in the new screen interface.

9. The method according to claim 8, wherein obtaining attribute information of the activated device screen, and loading the page corresponding to the attribute information in the new screen interface comprises:
in response to the attribute information of the activated device screen being receiving a new message, displaying content of the new message in the new screen interface; and
in response to the attribute information of the activated device screen being operation of the user on an electronic device, displaying a preset information page in the new screen interface.

10. The method according to claim 1, further comprising:
after detecting an operation of unlocking the user interface locked state, closing the new screen interface.

11. An electronic device, comprising: a housing, a processor, a memory, a circuit board, and a power circuit, wherein the circuit board is arranged inside a space enclosed by the housing; the processor and the memory are disposed on the circuit board; the power circuit is configured to provide power for individual respective circuits or components of the electronic device; the memory is configured to store executable program codes; and the processor, by reading the executable program code stored in the memory, is configured to run a program corresponding to the executable program codes by reading the executable program codes stored in the memory, so as to perform following actions:
when an activated device screen is in a user interface locked state, displaying a prompting object of a new screen interface on the device screen;
detecting a touch operation of a user on the prompting object of the new screen interface;
judging whether the detected touch operation satisfies a preset information displaying condition; and
in response to the detected touch operation satisfying the preset information displaying condition, loading the new screen interface.

12. The electronic device according to claim 11, wherein displaying the prompting object of the new screen interface on the device screen comprises:
displaying the prompting object of the new screen interface on a preset position of the device screen.

13. The electronic device according to claim 12, wherein the processor is further configured to perform:
determining a color of the prompting object of the new screen interface,
wherein determining the color of the prompting object of the new screen interface comprises:
obtaining a pixel value of each of pixels in a preset range centered on the preset position;
calculating a mean pixel value according to pixel values of the pixels in the preset range;
inquiring a mapping relationship between pixel values and reference pixel values, obtaining a reference pixel value corresponding to the mean pixel value; and
setting the color of the prompting object of the new screen interface to the obtained reference pixel value.

14. The electronic device according to claim 11, wherein judging whether the detected touch operation satisfies the preset information displaying condition comprises:
in response to a displacement of dragging the prompting object of the new screen interface greater than a first distance threshold in a preset dragging direction on the device screen, determining the detected touch operation satisfies the preset information displaying condition.

15. The electronic device according to claim 11, wherein judging whether the detected touch operation satisfies the preset information displaying condition comprises:
in response to a displacement of dragging the prompting object of the new screen interface greater than a second distance threshold in a preset dragging direction on the device screen and smaller than a first distance threshold, calculating a time period from beginning of touching the prompting object of the new screen interface to releasing the prompting object of the new screen interface during dragging; and
in response to the time period greater than a preset time period threshold, determining that the detected touch operation satisfies the preset information displaying condition.

16. The electronic device according to claim 11, wherein the processor is further configured to perform:
in response to the displayed prompting object of the new screen interface satisfying a preset enhanced prompting condition, displaying an enhanced prompting animation corresponding to the enhanced prompting condition.

17. The electronic device according to claim 16, wherein the enhanced prompting condition comprises:
displaying, for a first time, the prompting object of the new screen interface during a preset time period; and/or
failing to detect the touch operation of the user on the prompting object of the new screen interface during a preset time period.

18. The electronic device according to claim 11, wherein loading the new screen interface comprises:
obtaining attribute information of the activated device screen, and loading a page corresponding to the attribute information in the new screen interface.

19. The electronic device according to claim 18, wherein obtaining attribute information of the activated device screen, and loading the page corresponding to the attribute information in the new screen interface comprises:
in response to the attribute information of the activated device screen being receiving a new message, displaying content of the new message in the new screen interface; and
in response to the attribute information of the activated device screen being operation of the user on an electronic device, displaying a preset information page in the new screen interface.

20. A non-transitory computer storage medium, configured to store an application, wherein the application is configured to perform following actions:
when an activated device screen is in a user interface locked state, displaying a prompting object of a new screen interface on the device screen;
detecting a touch operation of a user on the prompting object of the new screen interface;
judging whether the detected touch operation satisfies a preset information displaying condition; and
in response to the detected touch operation satisfying the preset information displaying condition, loading the new screen interface.
